(19) United States
(12) Patent Application Publication
(10) Pub. No.: US 2019/0380515 A1
(43) Pub. Date: Dec. 19, 2019

(54) Bracket Mount System

(71) Applicant: Ana Teresa Azpurua Baez, Miami, FL (US)

(72) Inventor: Ana Teresa Azpurua Baez, Miami, FL (US)

(21) Appl. No.: 16/443,854

(22) Filed: Jun. 17, 2019

Related U.S. Application Data
(60) Provisional application No. 62/685,909, filed on Jun. 15, 2018.

(51) Int. Cl. A47G 7/00; A01G 31/02; A01G 22/63; F16M 13/02

(52) U.S. Cl. CPC A47G 7/00; F16M 13/02; A01G 22/63; A01G 31/02

(57) ABSTRACT

A bracket mount system kit comprising at least one bracket and a fastener. The bracket has a plurality of arms that may be bent to accommodate decorative material such as air plants and epiphytes. The bracket is secured to a surface with the fastener.

### PRIORITY claim

This non-provisional application claims priority to provisional application No. 62/685,909, filed Jun. 15, 2018, titled Bracket Mount System, the entire contents of which are incorporated herein by reference.

### FIELD OF THE DISCLOSURE

The present disclosure relates to methods and apparatuses for a bracket mount system. More specifically, the present disclosure presents a bracket mount system for use in connection with light-weight or low-density decorative material such as faux and live air plants.

### BACKGROUND OF THE DISCLOSURE

Air plants are popular to use in interior decorating. Air plants are of the genus, Tillandsia, most of which are epiphytes, meaning these plants do not have a typical plant root system and do not grow from soil in the ground. Instead, they typically grow on other plants in forests. This allows the air plants to have better access to sunlight. Air plants receive nutrient from the air and water. Similar to air plants are other epiphytes such as orchids and Spanish moss.

Because air plants do not need to grow in soil, they are versatile for use in both interior and exterior decor. In addition, air plants are beneficial for indoor air quality because they release oxygen during the night. The foliage can range in color from green to yellow to red to purple, also making them attractive in decor. Air plants are also easy to maintain: soak them in water, place in decorative fashion, and then re-soak when the air plant is completely dry. Air plants should not be exposed to water daily or be mounted or contained in an apparatus that holds water. Air plants should be removed from their container or mount, soaked, for a couple of hours every week or so, and then returned to its container or mount. Misting the leaves is usually not sufficient. Air plants should have plenty of ventilation. Therefore, there is much interest and desire to have air plants in and around the home, in offices, and in other commercial settings.

Traditionally, air plants and other epiphytes are displayed in vivarium, terrariums, small pots, sea urchin exoskeletons, shells, vases, bowls, vertical garden walls, re-purposed light bulbs, wall planters, platters, and apothecary jars. Some more creative decorative arrangement may involve tacking, gluing, or pinning the air plant onto frames or fabrics, pinning, nailing, or stapling the air plants to a surface, or constricting the air plants with springs. However, some metals such as copper are toxic to air plants. Air plants do not need to be in an upright position in order to flourish. Other popular ways of decorating with air plants include integrating them with repurposed materials such as wood, cork, stone, or glass.

However, traditional decorative and functional mounts and containers to not provide for a truly minimalist aesthetic and simple and user-friendly design. For example, many containers such as pots, shells, and terrariums do not provide enough air flow or hold too much moisture. As a result, the air plants will not flourish and may die prematurely. Many of these containers are relatively heavy, bulky, and cover much of the air plant. This takes away from the plant's natural beauty and does not provide for a truly minimalist design and decoration. Furthermore, as the air plant grows, it will need a larger container. Traditional pots and containers are also relatively heavy for wall mounting. Traditional mounting techniques of nailing, pinning, stapling, constricting, and gluing also may damage the air plant and makes re-mounting messy, difficult, and unsightly.

### SUMMARY OF THE DISCLOSURE

What is needed are the bracket mount systems according to the disclosure. More specifically, a bracket comprises a plurality of arms that meet at a center. The center contains an opening suitable to accommodate a fastener. The arms are preferably slim and have edges and ends. The arms contain at least one joint for flexing and bending the arms. Some arms have notches or nodules or both. The notches and nodules aid in bending the arms and holding decorative material.

Decorative material includes air plants that are either faux or live and any other material that may be mounted to a surface. The bracket is placed against a surface such as a wall or a tree. The bracket is fastened to the surface with a fastener at the center. The arms are bent perpendicularly to sick out from the surface. The decorative material is placed at the center of the bracket, within the arms. The arms may be left in a perpendicular position or may be further adjusted, folded, crossed, or bent to accommodate and hold a variety of shape, size, and weight of the decorative material.

The bracket mount system can be presented in a kit that includes at least one bracket and at least one fastener. Some kits may include a set of instructions. Some kits may include a sample or full size of either faux or live decorative material such as an air plant.

### BRIEF DESCRIPTION OF THE DRAWINGS

The accompanying drawings are incorporated in and constitute a part of this specification, illustrate several embodiments of the disclosure, and together with the description, serve to explain the principles of the disclosure.

FIG. 1 shows an exemplary embodiment of a bracket.

FIG. 2 shows an exemplary bracket mount system kit.

FIG. 3 shows an exemplary bracket mounted to a surface such as a tree.

FIG. 4 shows an exemplary bracket mounted with decorating material.

FIG. 5 shows an exemplary configuration of a bracket mount system.

FIG. 6 shows an exemplary decoration with a plurality of bracket mount system complexes.

FIG. 7 shows an exemplary bracket mount system configured to accommodate a budding epiphyte.

FIG. 8 shows exemplary method steps for implementing a bracket mount system.

### NUMBERS OF THE FIGURES

1. Bracket

5. Arm

10. Center

15. Opening

25. Arm Edge

30. Arm End

35. Joint

40. Notch.

45. Nodule

50. Decorative Material

55. Kit

60. Fastener

65. Surface

70. Complex

### DETAILED DESCRIPTION

The present disclosure provides generally a bracket mount system. According to the present disclosure, a bracket mount system generally comprises a bracket with a plurality of arms and at least one fastener. A fastener as used herein includes any device used for attaching or securing the bracket to a surface. Examples of fasteners include screws, nails, staples, adhesive, hook-and-loop closures, pins, tack, tape, anchors, hooks, and glue. While inspired by a way to simply and cleanly mount air plants to a surface, the bracket mount system, herein referred to as the system, can be used with artificial or faux plants, other epiphytes such as orchids, and with other decorative items, collectively referred to herein as decorative materials.

Generally, a system is presented in a kit with at least one fastener and at least one bracket. The bracket is surface mounted with a fastener to a surface such as a wall. Preferably, the bracket is mounted to the surface at its center. The bracket has a plurality of arms that may bend. A bracket may have one, two, three, four, or more arms. In preferred embodiments, a bracket has three arms. The arms are bent and folded away from the surface to be perpendicular from the surface. The decorative material is placed in the center of the bracket with the arms bent out around the decorative material to hold it in place.

The system allows the decorative material access to plenty of light and ventilation. For epiphytes such as air plants, moisture will not collect, and the plant will not be damaged because the plant is not directly mounted to a surface. The system provides for a minimalistic design that blends in with the plant leaves or with other decorating material used.

In the following sections, detailed descriptions of examples and methods of the disclosure will be given. The description of both preferred and alternative examples are exemplary only, and it is understood that a those skilled in the art that variations, modifications, and alterations may be apparent. It is therefore to be understood that the examples do not limit the broadness of the aspects of the underlying disclosure as defined by the claims.

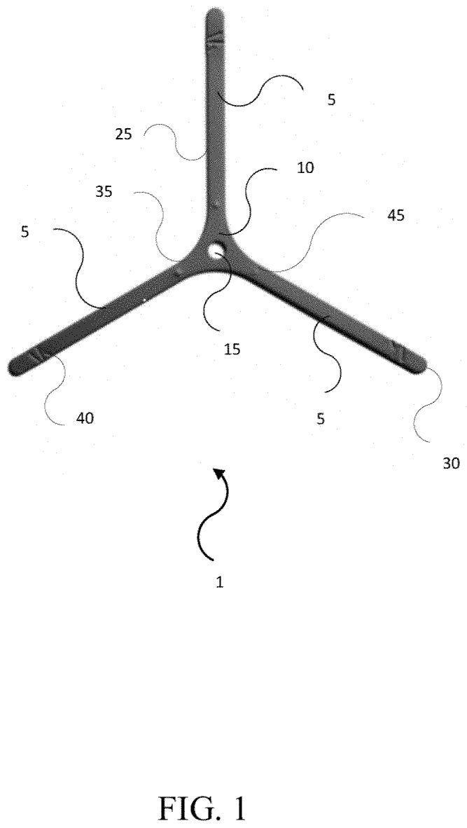

Referring now to FIG. 1, an exemplary embodiment of a bracket is shown. In preferred embodiments, a bracket has three arms. Each arm may be relatively slender, protruding from a center. The center may have an opening to accommodate a fastener such as a screw. Exemplary arm lengths may be approximately 5-200 mm with a preferred length of about 55 mm. Exemplary arm widths may be approximately 1-20 mm with a preferred length of about 4 mm. Brackets may be relatively thin with a thickness of 0.5 mm to approximately 5 mm with a preferred thickness of 1 mm.

The arms may be arranged equidistant from each other or may be non-equidistant and asymmetrical. The arms may have edges that are smooth or beveled. The arm ends may be rounded, squared, pointed, or chiseled.

The bracket and arms may be constructed out of various materials such as plastics, metals, and silicones, and combinations thereof. The material may be natural, synthetic, or biodegradable such as cardboard or plastic made from corn waste. The bracket and arms may be presented in any color. The arms may or may not have joints, weak points, notches, or cutouts to make bending the arms easier. Some embodiments have smooth arms. The arms may have a textured coating to increase a frictional grip or may be smooth.

The arms should be able to bend in at least one place at each arm. In preferred embodiments, the arms are bent close to the center of the bracket. The arms may be bent to position and straightened flat. The arms may be re-positioned without the need to remove the bracket from the surface and without damaging the decorative material.

Exemplary brackets may have a simple cutout or opening at the center, with very slim, smooth arms. A preferred length may be approximately two to three inches. A system kit may include brackets of various sizes for varying decorating schemes and plans.

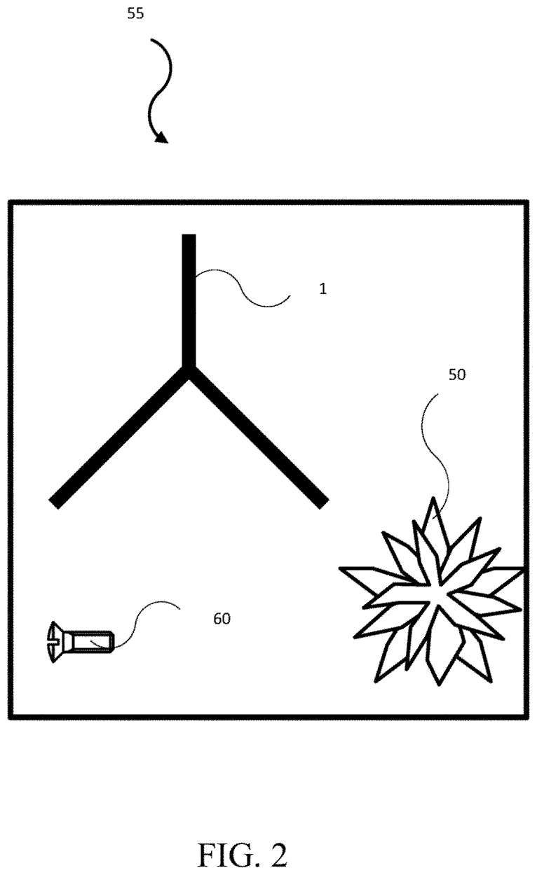

Referring now to FIG. 2, an exemplary bracket mounts systems kit is shown. In the present embodiment, the bracket contains a nodule at the arms close to the center. The modules may aid in surface placement or may aid in bonding. A kit with instructions for mounting the bracket, placing the decorative material (in the case an air plant), and caring for and maintaining the air plant may be included. In some embodiments, a kit may include decorating material.

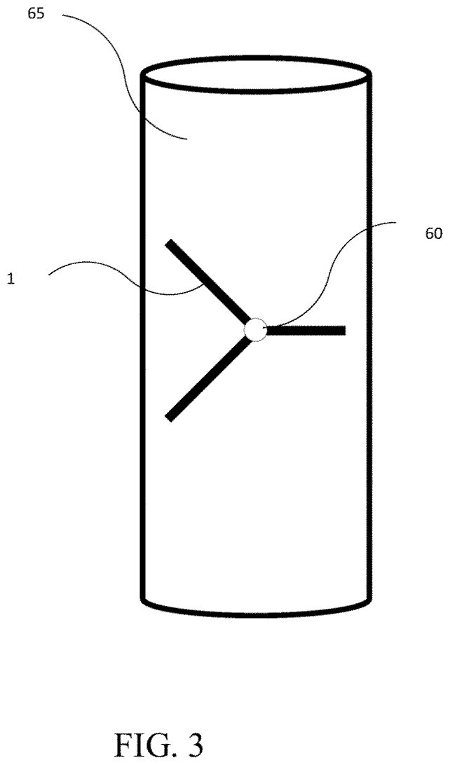

Referring now to FIG. 3, an exemplary bracket is mounted to a surface such as a tree. In this example, the bracket is mounted with a screw fastener to a tree outdoors. This configuration mimics the natural placement of epiphytes on trees in forests. In this example, epiphytes may be watered directly without the need for removal and replacement. Epiphytes will also be able to freely access atmospheric humidity, rainwater, and sunshine.

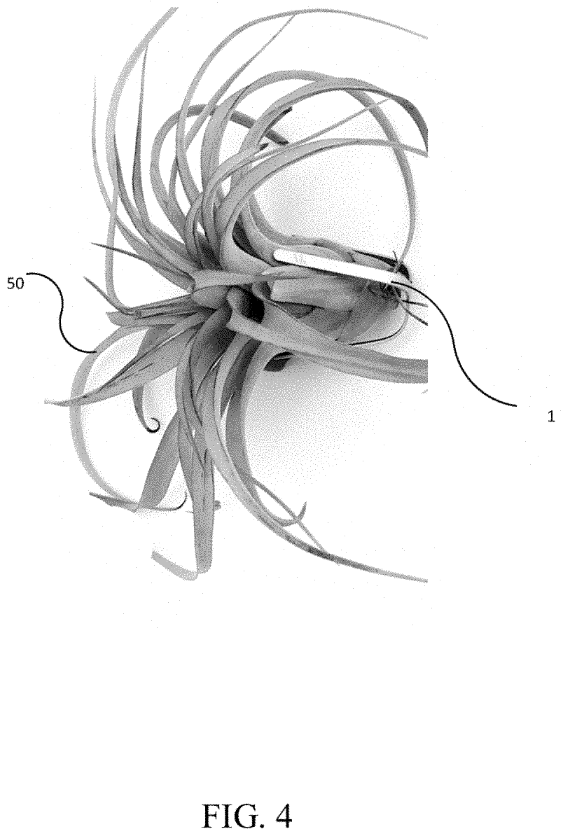

Referring now to FIG. 4, an exemplary bracket mounted to a surface such as a wall with decorating material is shown. Bracket arms may be bent or folded at an acute, right, or obtuse angle from the surface or center of the bracket to accommodate various sizes of decorating material.

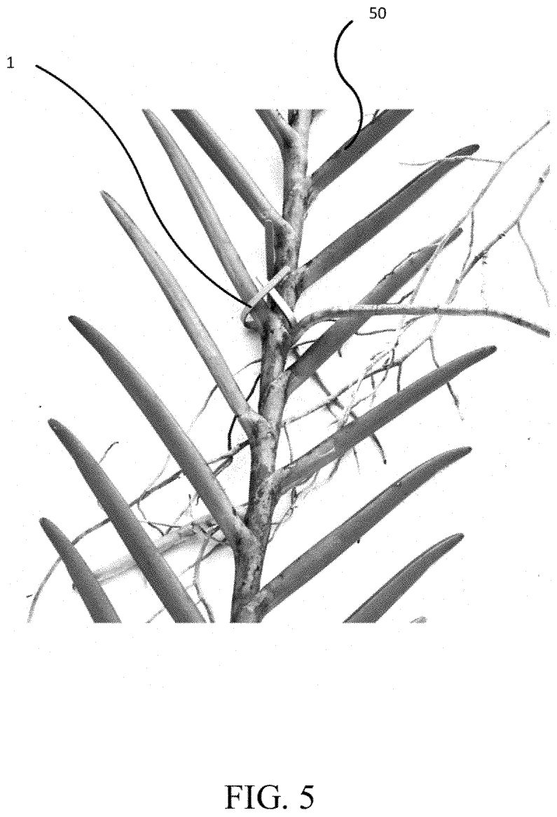

Referring now to FIG. 5, an exemplary configuration of a bracket mount system is shown. In the exemplary embodiment, a bracket is configured to hold a relatively large decorating material such as epiphyte of the Vanda genus that comprises orchids. In this example, the decorating material, the orchid, is held by a bracket about the stem of the orchid with the orchid top and bottom extending beyond the length and width of the bracket. The bracket arms may be twisted or folded over one another.

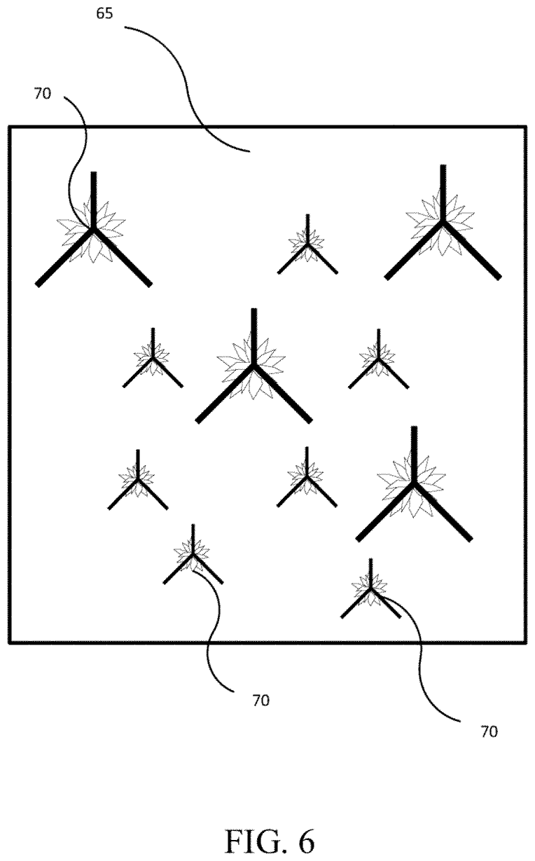

Referring now to FIG. 6, an exemplary decoration with a plurality of bracket mount system complexes is shown. A mounting position such as the placement or arrangement on a surface is decided. A bracket mount system complex comprises a bracket, a fastener, and decorating material. The decorating material is held in place by the bracket arms against the center of the bracket. In some embodiments and method steps, the plurality of bracket mount system complexes may be fastened to a surface such as a wall or a tree in a desired pattern. Bracket mount systems may be removed and repositioned. Decorating material may be integrated with bracket before or after mounting.

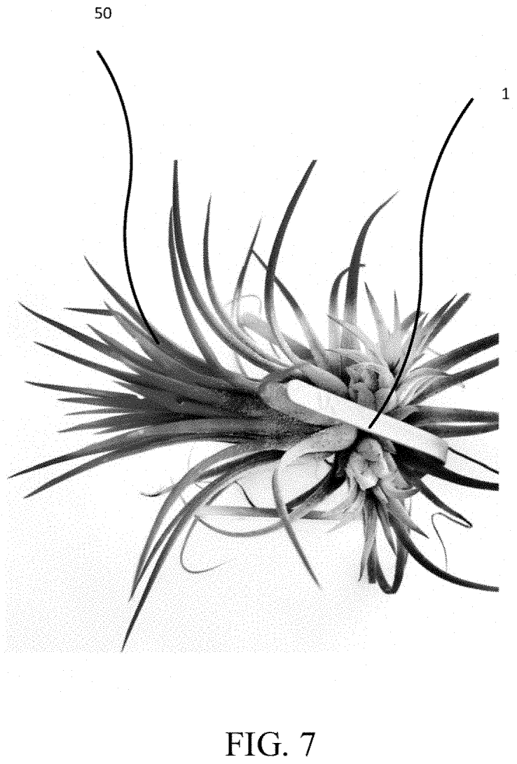

Referring now to FIG. 7, an exemplary bracket mount system configured to accommodate a budding epiphyte is shown. In an epiphyte's natural life cycle, the plant will bud as its form of reproduction. The exemplary bracket mount system accommodates natural budding. The bracket arms may be adjusted. In some embodiments, the bracket arms may extend perpendicularly from the center of the bracket and the surface.

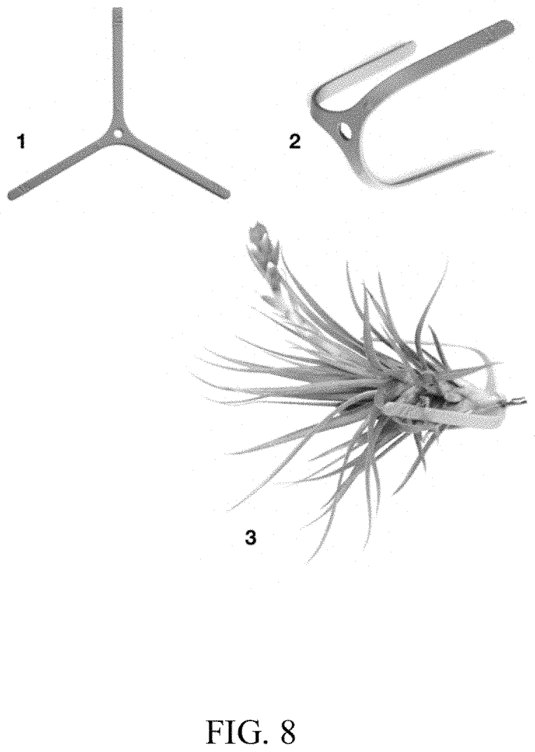

Referring now to FIG. 8, exemplary method steps for implementing a bracket mount system are shown. In the example, a bracket is placed flat on a surface for surface mounting. The bracket is affixed to the surface with a fastener. The bracket arms are bent at either a nodule or notch or other bend indicator. Decorating material such as a live or faux epiphyte is situated between the bracket arms. The arms are adjusted to hold the decorating material in place.

### CONCLUSION

A number of embodiments of the present disclosure have been described. While this specification contains many specific implementation details, these should not be construed as limitations on the scope of any disclosures or of what may be claimed, but as descriptions of features specific to particular embodiments of the present disclosure.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order show, or sequential order, to achieve desirable results. Nevertheless, it will be understood that various modifications may be made without departing from the spirit and scope of the claimed disclosure.

What is claimed is:

1. A bracket mount system kit, the system kit comprising
a. At least one fastener; and
b. At least one bracket,
Wherein the at least one bracket comprises a plurality of arms, a center with an opening, a joint, and either a notch or a nodule.

2. The system kit of claim 1 further comprising decorative material.

3. The system kit of claim 1 wherein the bracket is comprised of a semi-rigid material and is capable of being bent.

4. The system kit of claim 2 wherein the decorative material is natural or faux.

5. The system kit of claim 2 wherein the decorative material is an air plant.

6. The system kit of claim 2 wherein the decorative material is an orchid.

7. A method of implementing the bracket mount system kit of claim 1, the method steps comprising
a. Selecting a mount position;
b. Holding a bracket to a surface;
c. Implementing a fastener to attach the bracket to the surface,
d. Positioning bracket arms to accommodate decorative material;
e. Inserting the decorative material; and
f. Adjusting the bracket arm position.

8. The method steps of claim 7 whereby the bracket arms are positioned perpendicularly from the surface.

9. The method steps of claim 7 whereby the bracket arms are positioned diagonally from the surface.

10. The method steps of claim 8 further comprising inserting decorative material between the arms and against the bracket center.

11. The method steps of claim 10 further comprising folding or crossing the arms over one another to accommodate large or heavy decorative material.

12. The method steps of claim 10 further comprising twisting the arms to accommodate large or heavy decorative material.

13. The method steps of claim 10 whereby the arms accommodate a budding epiphyte.

14. The method steps of claim 7 whereby the bracket arms are positioned by bending each arm at a notch or a nodule.

15. The method steps of claim 7 hereby a system complex is formed comprising a bracket, a fastener, and decorative material.

16. The method steps of claim 15 further comprising arranging a plurality of system complexes on a surface to create a design or pattern.

17. The method steps of claim 7 wherein the surface is a tree.

18. The method steps of claim 7 wherein the surface is a wall.

19. The methods steps of claim 16 wherein the surface is a tree.

20. The method steps of claim 16 wherein the surface is a wall.
